(19) United States
(12) Patent Application Publication
(10) Pub. No.: US 2014/0372221 A1
(43) Pub. Date: Dec. 18, 2014

(54) METHODS AND SYSTEMS FOR UTILIZING VEHICLE TELEMATICS

(71) Applicants: Zulfiqar N. Momin, Sugarland, TX (US); Ahmed Moledina, Austin, TX (US)

(72) Inventors: Zulfiqar N. Momin, Sugarland, TX (US); Ahmed Moledina, Austin, TX (US)

(73) Assignee: FUEL SIGNAL, Austin, TX (US)

(21) Appl. No.: 14/161,012

(22) Filed: Jan. 22, 2014

Related U.S. Application Data
(60) Provisional application No. 61/836,644, filed on Jun. 18, 2013.

(51) Int. Cl. G06Q 30/02

(52) U.S. Cl. CPC G06Q 30/0266
USPC 705/14.63

(57) ABSTRACT

Embodiments disclosed herein provide systems and methods for a first retailer to attract users to the first retailer's location over a second retailer's location by transmitting timely promotions to the user based on the users location, the retailers location, and metrics for a vehicle associated with the user. Specifically, embodiments may determine a vehicles level of fuel is below a fuel threshold and transmit information associated with retailers that are in close proximity to the vehicle.

### CROSS-REFERENCE TO RELATED APPLICATIONS

This application claims a benefit of priority under 35 U.S.C. §119 to Provisional Application No. 61/836,644 filed on Jun. 18, 2013, entitled “SYSTEM, METHOD AND COMPUTER PROGRAM PRODUCT FOR FACILITATING COMMUTATION OF LOCATION-BASED COLLABORATIVE DISCOUNTS BETWEEN USER(S) AND SERVICE PROVIDER(S) UPON LEARNING REAL-TIME VEHICLE TELEMATICS DATA,” which is fully incorporated herein by reference in its entirety.

### BACKGROUND INFORMATION

1. Field of the Disclosure

Examples of the present disclosure relate to techniques for communicating location based information. More particularly, embodiments are related to communicating promotions responsive to determining a fuel level of a vehicle.

2. Background

Conventional location based promotions provide an incentive to users to purchase goods and services from retailers, merchants, service providers, etc. (referred to individually and collectively hereinafter as “retailers”). A user may receive the conventional location based promotions when the user is in close proximity to a retailer.

However, a user may be inundated with promotions from retailers that they have no intention of buying goods and/or services from. Therefore, conventional location based discounts may become an unwanted intrusion for a user, and/or the user may end up not purchasing any goods or services based on the received promotions.

Furthermore, conventional location based promotions require a user to perform an active step to receive the promotions. For example, conventional location based promotions require that the user log into a mobile application to transmit information identifying the location of the user before receiving the promotions associated with the user's location.

Situations may arise where a user is either unable to perform actions to receive promotions or unaware that the user may desire a promotion associated with a retailer. For example, if a user is driving a vehicle that is low on fuel or energy or the vehicle is having a mechanical problem, the user may not be able to perform actions to transmit the location of the user or the user may not realize that the vehicle requires maintenance.

Accordingly, needs exists for more efficient and effective location based promotions that are communicated to a user responsive to real-time metrics associated with a vehicle.

### SUMMARY

Embodiments disclosed herein provide systems and methods for a first retailer to attract users to the first retailer's location over a second retailer's location by transmitting timely promotions to the user, wherein the promotions may be based on the user's location, the retailer's location, and metrics for a vehicle associated with the user. Embodiments may determine a vehicle's level of fuel, electrical energy, and/or source of power (referred to hereinafter independently and collectively as fuel). Subsequently, if the vehicle's fuel level is below a fuel threshold, information associated with retailers in close proximity to the vehicle may be transmitted to a client computing device corresponding with the vehicle. Retailers may not only be able to receive new customers for fuel sales, but they may also have the opportunity to up sale or cross sale merchandise sold within the retailer. Thus, increasing the retailer's bottom line and sales.

Retailers may be able to increase or decrease their traffic levels by transmitting promotions at a particular time to manage a seamless traffic flow of customers. Retailers may also be able to determine a number of vehicles that are within a geographic area at any given time period. This information may be useful for a retailer to determine if the retailer will need more or less fuel based on the number of vehicles in close proximity that require fuel. This information may also be utilized to determine fuel price fluctuations. Retailers may also be able to track real-time data of how much time each user spends at a particular gas station based on tracking the location of a user over time periods. Furthermore, this information may be valuable to the retailers to promote sales to the users in real-time, wherein fuel prices may be lower or higher when a group of customers visits a retailer to purchase fuel within a given period of time.

Embodiments may also be configured to transmit travel related information in response to a present condition of a trip, such as vehicle conditions, road or weather conditions, traveler conditions, time of travel, etc. For example, if a vehicle is low on gasoline or has a mechanical problem, it may be helpful for a user associated with the vehicle to be presented with information corresponding to the locations of gas stations or repair shops in close proximity to the vehicle. Or, if a user associated with the vehicle is hungry or tired, it may be helpful to present information to the user that is associated with upcoming restaurants or rest stops.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts one topology for attracting users to visit retailers.

FIG. 2 depicts one embodiment of a logic server.

FIG. 3 depicts one embodiment of a client computing device.

FIG. 4 depicts one embodiment of a retailer computing device.

FIG. 5 depicts one embodiment of a method for transmitting promotions responsive to a level of fuel in a vehicle being lower than a fuel threshold.

FIG. 6 depicts one embodiment a method for transmitting a promotion to a plurality of client computing devices associated with different vehicles responsive to a level of fuel in the vehicles being lower than a fuel threshold.

FIG. 7 depicts one embodiment a method for activating a promotion if enough users purchase goods and/or services associated with the promotion over a given time period.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments disclosed herein are configured to combine the ability for a vehicle to navigate between two locations with being presented with timely promotions for gas, dining, shopping, etc. Furthermore, embodiments may be configured to present promotions to a user based on real-time vehicle telematics data. Embodiments may be configured to automatically track a level of fuel in a user's vehicle, and enable a retailer to push promotions or information to users operating separate vehicles that are low on fuel within a given geographic region. Specifically, embodiments may automatically locate and group users of vehicles with other users of vehicles, and transmit promotion to purchase fuel from a retailer within a geographic area. The promotions may be an hourly sale to purchase fuel from the retailer, and if such a sales quota is met then each participating user may receive a discount on the goods and/or service purchased.

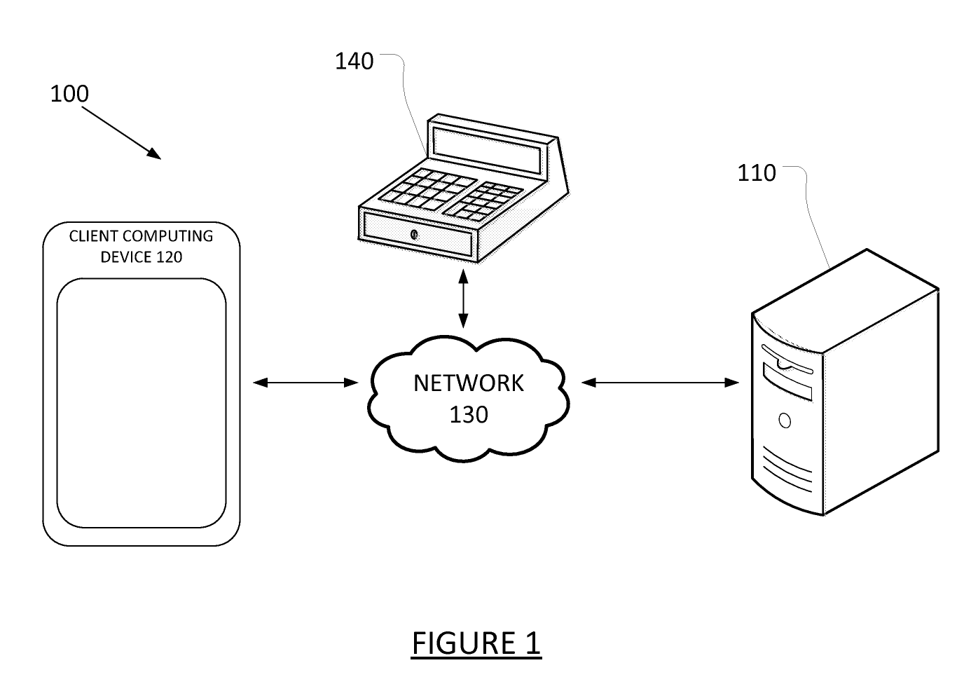

Turning now to FIG. 1, FIG. 1 depicts one topology 100 for attracting users to visit retailers. Topology 100 may include a logic server 110, client computing device 120, and a retailer computing device 140. The elements depicted in topology 100 may be communicatively coupled to each other over network 130.

Network 130 may be a wired or wireless network such as the Internet, an intranet, a LAN, a WAN, a NFC network, Bluetooth, infrared, radio frequency, a cellular network or another type of network. It will be understood that network 130 may be a combination of multiple different kinds of wired or wireless networks.

Logic server 110 may be a computing device, such as a general hardware platform server configured to support mobile applications, software, and the like executed on client computing device 120 and/or retailer computing device 140. Logic server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Logic server 110 may include any combination of one or more computer-usable or computer-readable media. For example, Logic server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Logic server 110 may be configured to receive promotions from retailer computing device 140, and transmit the promotions to client computing device 110. The promotions may be transmitted based on the location of the retailer associated with retailer computing device 140, the location of client computing device 120, and real-time metrics received from client computing device 120. In embodiments, a retailer may be any number of retailers, wholesalers, distributers of any number of goods and/or services. The promotions may be associated with a good and/or service offered by the retailer. The promotions may also be condition based, where if a user utilizes a first promotion to buy a good and/or service offered by a first retailer, the retailer may be presented with a second promotion for a good and/or service provided by a second retailer, which may be time sensitive or geographically based.

Client computing device 120 may be a smart phone, tablet computer, laptop computer, a computer embedded within a vehicle, a computer coupled to a vehicle's processor and/or the vehicle's sensors, personal data assistant, or any other type of mobile device with a hardware processor that is configured to process instructions and connect to one or more portions of network 130. Client computing device 120 may be configured to determine the location of client computing device 120 and determine real-time metrics associated with a vehicle. Client computing device 120 may be further configured to transmit the determined location of client computing device 120 and the real-time metrics to logic server 110.

Retailer computing device 140 may be a hardware computing device that is associated with a specific retailer, chain of retailers, sets of retailers that a commonly owned, etc. Retailer computing device 140 may be configured to determine information associated with promotions for goods and/or services and transmit the determined information associated with the promotions to logic server 110. The promotions may be configured to be presented to users when the users are in close proximity to a location associated with a retailer. One skilled in the art will appreciate that the goods and/or services may include a number of goods and/or services, including: gasoline, e85, electric fuel, routine vehicle maintenance, oil changes, tire repair, A/C repair, etc. Retailer computing device 140 may also be configured to determine and transmit information corresponding to the location of at least one retailer associated with retailer computing device 140 to logic server 110.

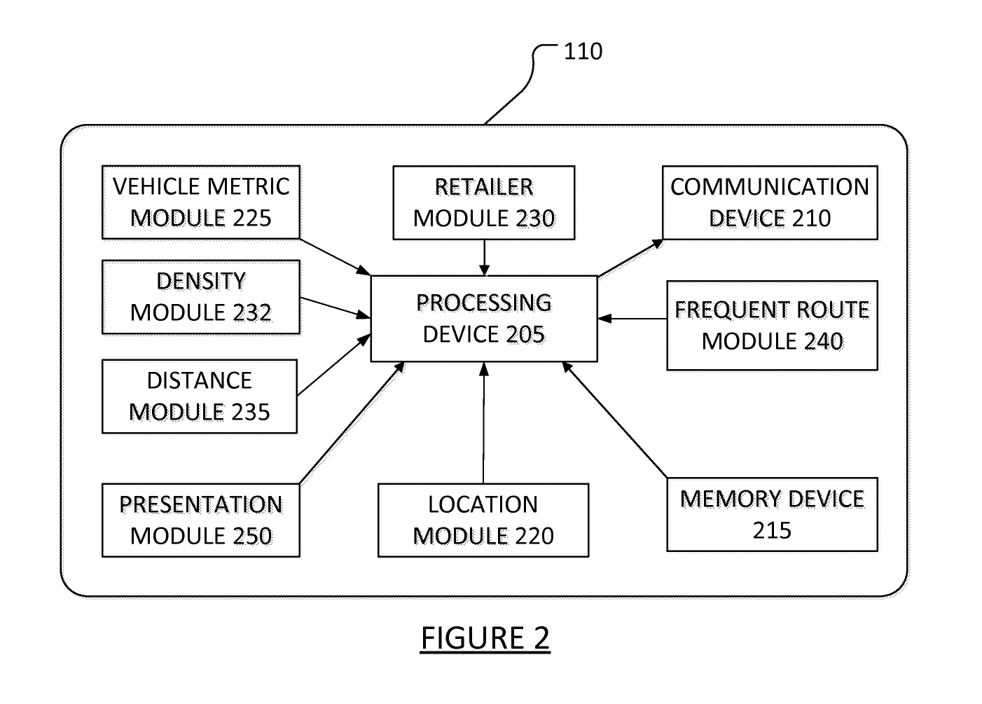

FIG. 2 depicts one embodiment of logic server 110. Logic server 110 may include a processing device 205, a communication device 210, a memory device 215, a location module 220, a vehicle metric module 225, a retailer module 230, a density module 232, a distance module 235, a frequent route module 240, and a presentation module 250.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of logic server 110 or software associated with other elements of logic server 110.

Communication device 210 may be a device that allows logic server 110 to communicate with another device over a wireless or wired network, such as network 130. Communication device 210 may include one or more wireless transceivers for performing wireless communication and/or one or more communication ports for performing wired communication. Communication device 210 may be configured to communicate data over a plurality of different standard and/or protocols.

Memory device 215 may be a device that stores data generated or received by logic server 110. Memory device 215 may include, but is not limited to a hard disc drive, an optical disc drive, and/or a flash memory drive. In embodiments, memory device 215 may be configured to store information received from a client computing device and/or a retailer computing device. The information stored within memory device 215 may be accessed by processing device 205, communication device 210, and/or modules 215, 220, 225, 230, 232, 235, 240, 250. In embodiments, memory device 215 may include a database configured to store vehicle information associated with a client computing device or promotion information associated with a retailer computing device. For example, memory device 215 may be configured to store information corresponding to a location of a vehicle, a fuel threshold for the vehicle, retailers that a user associated with a client computing device prefers to visit, type of fuel used by the vehicle, frequent routes that the vehicle takes, etc. Further, memory device 215 may be configured to store information corresponding to a location of a retailer, types of goods and/or services offered by the retailer, discounts, coupons, promotions, etc. for the retailer, etc.

Location module 220 may be a hardware processing device configured to determine the location of a retailer or a client computing device associated with a vehicle. A location may be represented in geographic coordinates, Cartesian coordinates, e.g., an (x, y) point on a map if the map is divided into a Cartesian plane, and/or may be represented using reference points.

In embodiments, location module 220 may determine the location of a retailer responsive to an employee associated with a retailer performing actions to enter location information associated with the location of the retail computing device. The location information may be subsequently transmitted to logic server 110. Responsive to receiving the location information associated with the retailer, location module 220 may store the location information within an entry of a database within memory device 215 associated with the retailer.

Location module 220 may be configured to determine the location of a client computing device associated with a vehicle responsive to receiving location information from the client computing device. In embodiments, location module 220 may be configured to receive the location information of the client computing device associated with vehicle at set intervals, which may be any desired period of time (e.g., every 1/10th of a second, every second, every minute, every ten minutes, etc.) or responsive to receiving vehicle metric information associated with the vehicle. For example, responsive to receiving vehicle metric information indicating that a level of fuel of the vehicle is below a fuel threshold level, location module 220 may determine the location of the client computing device associated with the vehicle. Location module 220 may determine the location of the client computing device via any known means, such as a RTLS WiFi, radar, mobile device tracking, time distance of arrival (TDOA) signals, short wave radio, Bluetooth, etc. Responsive to determining the location of the client computing device associated with the vehicle, location module 220 may store, within an entry of database within memory device 215 associated with the client computing device associated with the vehicle, the location information and a corresponding time stamp identifying the time that the location of the vehicle is determined.

Vehicle metric module 225 may be a hardware processing device configured to receive vehicle information from the client computing device associated with the vehicle. In embodiments, vehicle metric module 225 may receive information indicating that the vehicle is low on fuel, a fuel metric indicating that the vehicle has a certain number of miles to travel on the current gas tank, a fuel metric indicating the number of fuel units till empty, a fuel metric indicating the maximum number of fuel units the vehicle may store (i.e., the size of the fuel tank), maintenance information corresponding to the vehicle, such as a check engine light, oil level, etc., or a number of fuel units required to fill up the vehicle.

In embodiments, vehicle metric module 225 may receive the vehicle information at set intervals, which may be any desired period of time (e.g., every 1/10th of a second, every second, every minute, every ten minutes, every hour, every day, a etc.), responsive to a fuel threshold level for the vehicle being met, such as the vehicle has ten miles, twenty miles, fifty miles, etc. before the tank is empty, or some other action occurring, such as a low-level fuel light being activated. In further embodiments, vehicle metric module 225 may be configured to receive telematic system information associated with a vehicle.

Retailer module 230 may be a hardware processor configured to receive retailer information from a retail computing device associated with a retailer. The retailer information may include an inventory of products carried or services offered by the retailer, a promotion for goods and/or services, such as a coupon or promo code, and a location of the retailer. Retailer module 230 may also be configured to receive business rules associated with when a promotion or what type of promotion for goods and/or services is transmitted to client computing devices associated with vehicles. In embodiments, the business rules may be set by a user of a client computing device associated with a vehicle, by an administrator associated with a retailer, and/or default settings set by any desired third party.

In one embodiment, the business rules may be associated with a distance between the vehicle and the retailer, a received fuel metric associated with the vehicle, a vehicle's telematics information, and/or a number of vehicles within a given distance over a set period of time from the location of the retailer having a fuel metric being lower than a fuel threshold. For example, retailer module 230 may receive a first business rule to transmit a first promotion to a first vehicle responsive to receiving a fuel metric from the first vehicle indicating that the first vehicle has fifty miles before the first vehicle runs out of fuel and distance information indicating that the first vehicle is within a distance threshold from the location of the retailer. The first promotion may be associated with the fuel metric such as a price discount off an amount of fuel, and the distance threshold may also be associated with the fuel metric, where the vehicle is able to safely drive to the retailer.

Additionally, the first promotion may be associated with a number of fuel units based on the amount of fuel units currently in the vehicle, a maximum number of fuel units capable of being stored in the vehicle, a distance from the vehicle to the retailer, and an average fuel unit consumer per distance unit between the vehicle and the retailer. In other words, the first promotion may be a discount for an amount of fuel that a user of the vehicle may purchase to be at maximum fuel capacity upon filling up at the retailer, without the amount exceeding the maximum fuel capacity of the vehicle.

In a second embodiment, a second promotion may be associated with fuel, goods, and/or services offered by the retailer, such as snacks, drinks, car maintenance, etc., and may be presented in various forms such as cash, credit, rebate, reward points etc. The promotions may change over a time period, such that a greater discount may be provided during a heavy traffic time or lighter traffic timer periods.

In a third embodiment, a third promotion may be an hourly sale to purchase fuel from the retailer, and if such a sales quota is met then each participating user may receive a discount on the goods and/or services purchased.

In a fourth embodiment, a fourth promotion may be configured to be pushed to the client computing devices associated with vehicles, such that multiple users may remotely accept the fourth promotion from a retailer in real-time. The fourth promotion may allow the retailer to aggregate the user data to predict how many potential vehicles may travel to the retailer in a given time period. The fourth promotion may include additional discount offerings to drive more traffic to the retailer. Further, the retailer may randomly promote an offer to a desired quantity of customers (e.g. five customers) who may redeem the fourth promotion over the given time period to receive the fourth promotion. The push notification may be presented to the users and removed from the user's device if the user does not accept the fourth promotion within the given time period.

Thus, by utilizing different types of promotions at different time periods or promotions including different features of types promotions, a retailer may drive traffic to their location by selectively adjusting the promotions.

Density module 232 may be a hardware processor configured to transmit promotions to client computing devices associated with vehicles based on the number of vehicles within a given distance from a retailer or a geographic location. The promotions transmitted by density module 232 may be transmitted responsive to determining that the number of vehicles having low fuel within a given distance from the retailer is greater than a number threshold. In embodiments, a vehicle having low fuel may indicate the number of fuel units within the vehicle is lower that a fuel threshold. In embodiments, the amount of discount for a promotion may be proportional to the number of vehicles within the given distance being below the fuel threshold, wherein the more vehicles below the fuel threshold within the given distance, the greater the discount associated with the promotion.

In embodiments, the transmitted promotions by retailer module 230 or density module 232 may be time sensitive, where the transmitted promotions may only be redeemed for a certain amount of time, such as within the next ten minutes, hour, etc.

Distance module 235 may be a hardware processing device configured to calculate the distance between a vehicle and a retailer, and/or driving directions between the vehicle and the retailer. Distance module 235 may determine the distance between the vehicle and the retailer based on the location information associated with the vehicle and the location information associated with the retailer, map information associated with the surrounding environment (i.e. lengths of roads), and directions between the vehicle and the retailer. Distance module 235 may also be configured to be a navigation device that may provide driving instructions using a combination of text, symbols, voice guidance, and a moving map. Distance module 235 may calculate a route between the vehicle and the retailer as applied to the map information stored within memory device 215, all major actions (e.g. turning corners, crossroads, roundabouts, etc.) that are schematically depicts by arrows or other indicated overlaid on the route. The route may also include an action indicator showing the distance to the next actions, the name of the current road, an estimated time before arriving at the retailer, etc. Distance module 235 may also be configured to determine an estimated amount of fuel units required for the vehicle to drive from the vehicle's current location to the retailer. In embodiments, the estimated amount of fuel needed for the vehicle to arrive at the retailer based on the vehicles make, model, user's driving profile, preferred gasoline type, time of day, type of roads along the route, etc.

Frequent route module 240 may be a hardware processing device configured to determine a route a user may take, including routes entered by the user or frequent routes taken by a client computing device associated with the vehicle. Frequent route module 240 may be configured to determine that a vehicle frequently takes a route based on the time of day, day of the week, and the location data associated with the time of day and day of the week. For example, if a vehicle frequently travels (i.e. a percentage higher than a route threshold, such as 70%, 80%, 90% of the time, or a certain number of times) from a home location to a second location between 8 am and 9 am Monday through Friday, frequent route module 240 may determine that the vehicle will frequently take the route during that time period. Frequent route module 240 may be configured to determine retailers that are in close proximity to the frequent route and transmit promotions associated with a retailer to the vehicle before the vehicle is in close proximity to the retailer. Additionally, frequent route module 240 may be configured to transmit notifications or promotions to the vehicle if it is determined that the vehicle is in close proximity to a favorite retailer and it is estimated that the vehicle will run out of fuel while travelling along the frequent route. In embodiments, frequent route module 240 may be configured to learn a user's driving pattern during various time periods throughout the day. Such time periods may include lunch time, commuting to and/from work, wherein during such time periods location-based discounts may be provided in real time to provide discounts that are in close proximity to the location of the vehicle. Frequent route module 240 may also be configured to automatically determine the cheapest fuel along a frequent route, and transmit the fuel price and location of the corresponding retailer to the vehicle. Frequent route module 240 may also be configured to track the vehicle's mileage and gasoline expenses along the frequent routes.

Frequent route module 240 may also be configured to track a distance of a vehicle with low fuel to a retailer to predict if the vehicle will visit the retailer within a given time period. Based on the prediction, dynamic promotions may be transmitted to the vehicle in real-time. Various methods may be utilized to predict if the vehicle will visit the retailer within the given time period, such as vehicle speed, distance available to travel based on the vehicle's remaining fuel, previous behavior of user/driver, traffic, weather, etc. In embodiments, the prediction may be based on weather, and weather related promotions for specific goods and/or services may be transmitted to the vehicle, which may increase a retailer's bottom line. For example, an analysis of the weather temperature could lead to providing pertinent promotions for soft drinks when outside temperature is above a certain temperature or providing coffee or cappuccino discounts when the weather is below a certain temperature. The prediction may be further based on an algorithm that calculates driving time and helps the retailer to manage a seamless traffic flow at retailer's location to equalize the traffic flow and avoid congestion or longer waiting times by user at the retailer's location.

Presentation module 250 may be a hardware processing device configured to transmit promotions configured to be displayed on a graphical user interface for the client computing devices associated with the vehicle. The transmitted promotions may include the location of the retailer, the goods and/or services associated with the promotion, an amount of price reduction associated with the promotion, a barcode and/or a Q-code. In further embodiments, the promotions may be filtered according to predefined settings created by the user of a client computing device and/or an administrator of logic server 110. For example, if a plurality of retailers has provided promotions within a given geographic area, the filtered promotions may include a number of promotions associated with a single good provided by multiple retailers, each offering dynamic fuel discounts that vary throughout the day based on time of day, traffic patterns, etc. In further embodiments, promotions may be filtered by transmitting promotions for fuel from multiple retailers along with a complimentary item, such as a snack or drink. Thus, the promotions may be filtered to include a variety of real-time discounts associated with different retailers. The promotions may also be filtered via a number of business rules corresponding to user shopping preferences, user profile information, and whether items associated with promotions are currently in a retailers inventory. To this end, if a user has been presented with a plurality of promotions associated with a specific retailer, goods, and/or services but the user has not used the promotions, promotions associated with the retailers, goods and/or services for the unused promotion may be filtered and not presented to the user.

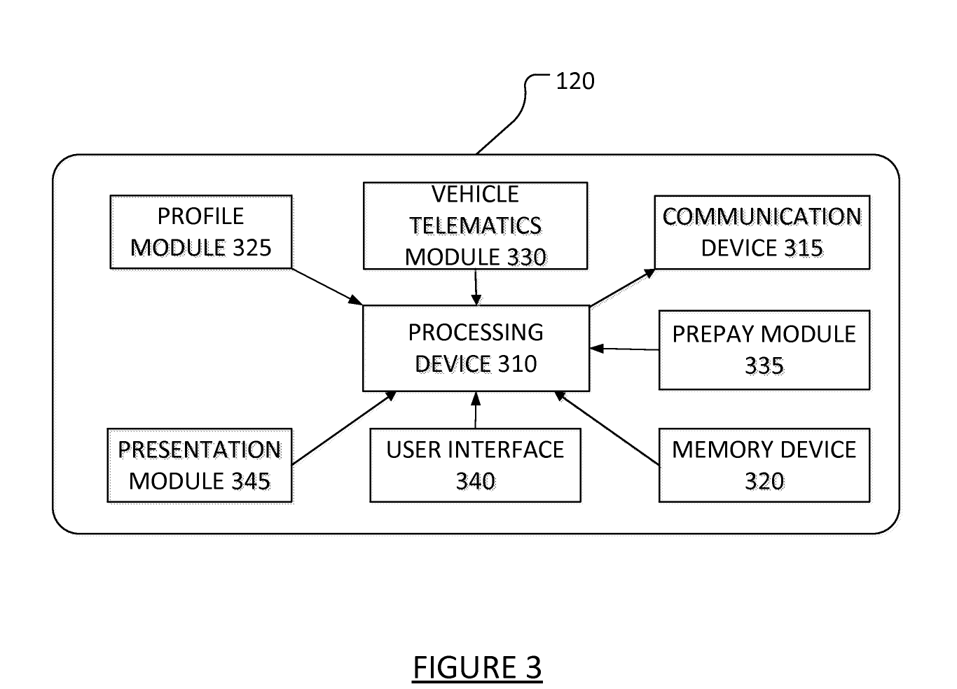

FIG. 3 depicts one embodiment of client computing device 120. Client computing devices 120 may be a smart phone, tablet computer, laptop computer, computer communicatively coupled to sensors embedded within vehicle, a, personal data assistant, or any other type of mobile device with a hardware processor that is configured to process instructions and connect to network 130, one or more portions of network 130. Client computing device 120 may include processing device 310, communication device 315, a memory device 320, a profile module 325, a vehicle telematics module 330, a prepay module 335, a user interface 340, and a presentation module 345.

Processing device 310 can include memory, e.g., read only memory (ROM) and random access memory (RAM), storing processor-executable instructions and one or more processors that execute the processor-executable instructions. In embodiments where processing device 310 includes two or more processors, the processors may operate in a parallel or a distributed manner. Processing device 310 may execute an operating system of client computing device 120 or software associated with other elements of client computing device 120.

Communication device 315 may be a device that allows client computing device 120 to communicate with another device, e.g., a logic server or a retailer computing device over a network. Communication device 315 may include one or more wireless transceivers for performing wireless communication and/or one or more communication ports for performing wired communication.

Memory device 320 may be a device configured to store data generated or received by client computing device 120. Memory device 320 may include, but is not limited to a hard disc drive, an optical disc drive, and/or a flash memory drive. Memory device 320 may be configured to store data associated with a vehicle's telematics data, a vehicle's make and/or model type, a user's profile, etc.

Profile module 325 may be a hardware processing device configured to allow the user of a client computing device server 120 to generate and create a user profile. The user profiles may include information stored in memory device 320 and/or other storage locations. The user profiles may include user information, vehicle information, and route information. The user profile may include for example, information identifying users (e.g., a username or handle, a number, an identifier, and/or other identifying information), security login information (e.g., a login code or password), payment information (e.g., credit card information), user set threshold information (e.g., transmit a promotion associated with fuel if the tank is a quarter filled, the tank has thirty miles till empty, a low fuel sensor is initiated, etc.), demographic information associated with users, purchase history of the user, driving style information associated with the user, or any other information associated with the user. The vehicle information may include information corresponding to the vehicle, such as the vehicle's make or model, the vehicles average mileage on a highway or standard road, a vehicle's maximum capacity for fuel, etc. The route information may include information corresponding to a user's favorite points of interests, retailers, frequent routes taken, etc.

Vehicle telematics module 330 may be a hardware processing device configured to determine a vehicle's telematics information (e.g., vehicle's battery power level, fuel units in the vehicle's tank, etc.). Vehicle telematics module 330 may be any system that is configured to be coupled via a vehicle's on-board self-diagnostics system (OBD) connector, RS232, RS485, or other interface or processor of the vehicle to receive vehicle diagnostic information. The vehicle diagnostic information may include engine sensors, fuel level sensors, oil level sensor, maintenance sensors, or any other type of sensor embedded within the vehicle. Responsive to determining a vehicle's telematics information, vehicle telematics module 330 may determine if an initiator action for a vehicle has been met (e.g. a check engine light has turned on, a low fuel sensor has turned on, a check engine/oil sensor light has turned on), and/or determine if the vehicle's telematics information is less than or greater than a corresponding threshold (e.g., a vehicle has less than three gallons of fuel left, a vehicle has less than fifty miles to travel on the current fuel level, a vehicle has greater than ninety percentage of its fuel capacity, etc.). Vehicle telematics module 330 may be configured to transmit the vehicle's telematics information to a logic server.

Prepay module 335 may be a hardware processor configured to determine the price for an amount of fuel required for a vehicle to reach a desired level at a retailer. The price for the amount of fuel the vehicle may require upon arriving at the retailer may be determined responsive to an initiator action occurring. Prepay module 330 may determine the amount of fuel required for the vehicle based on an amount of fuel in the vehicle when an initiator action takes place (e.g. the vehicle has two gallons of fuel when a low fuel light has turned on), the vehicle's maximum fuel capacity (e.g. the vehicle can store twenty gallons of fuel), an amount of fuel required for the vehicle to travel to a retailer that may be based on a vehicle make and model, road type, and/or user driving style (e.g. it may require the vehicle to use one gallon of fuel to travel to the retailer). First, prepay module 335 may determine the vehicle's estimated fuel level upon reaching the retailer (e.g. the vehicle's current fuel level minus the estimated amount of fuel required to travel to the retailer). Second, prepay module 335 may determine the difference between the vehicle's maximum fuel capacity and the vehicle's estimated fuel level upon reaching the retailer. Third, prepay module 335 may multiply the determined difference by the price of a desired fuel type, to determine the price for the amount of fuel required to maximize the vehicle's fuel level, wherein the desired fuel type may be preselected based on the user's preferences stored within the user's profile.

In one embodiment, prepay module 335 may be configured to allow for a transaction for the price for the amount of fuel over a wireless protocol (e.g. Near Field Communications protocol (NFC), ISO, ECMA, ETSI, etc.) at a pump or other point of sale associated with a retailer in response to the vehicle arriving at the retailer. Prepay module 335 may be configured to allow for transactions, data exchange and wireless connections between two devices in close proximity to each other, such as client computing device 120 and a retailer computing device. Prepay module 335 may be configured to allow for contactless payment and ticketing standards that may be used by the user of client computing device 120 to preform transactions. In embodiments, prepay module 335 may utilize NFC standards such that millions of contactless credit cards can be used for any mobile wallets. Thus, prepay module 335 may be utilized with cards, tags, and devices, including terminals, mobile devices and other consumer electronics devices to prepare transactions without a user leaving the vehicle.

In further embodiments, prepay module 335 may be configured to trigger a real-time financial credit approval to purchase the gas and other goods responsive to vehicle telematics module 330 determining that the vehicle is low on fuel. The trigger may query participating financial institutions based on the user's profile settings to receive information corresponding to a real-time credit approval or prepaid code, such that the user may redeem the amount to purchase gas or groceries at participating retailers. This prepaid card or code may eliminate credit card fees that a retailer may pay if the user chooses to pay by credit card at a point of sale associated with the retailer. In embodiments, the user may use the received code at gas pump by scanning or presenting the bar code displayed on user interface 340 to authenticate the purchase. Accordingly, credit providers may receive money from a bank account linked with a user's profile, and credit the deposit to the retailer's bank account in real-time or an EOD in a batch process. Furthermore, financial institutions may offer the credit to the user's in real-time. Thus, a real-time automatic credit approval inquiry based on the low fuel status of the vehicle may be triggered, which may eliminate credit card processing fees charged to the retailers by merchant processing banks.

User interface 340 may be a device that allows a user to interact with client computing device 120, logic server, or retailer computing device over a network. While one user interface is shown, the term “user interface” may include, but is not limited to being, a touch screen, a physical keyboard, a mouse, a camera, a video camera, a microphone, and/or a speaker. Utilizing user interface 340, a user may perform actions to enter user profile information, perform actions to accept a promotion, perform actions to set a navigation route, perform actions to set a list of desired retailers, perform actions to purchase goods and/or services associated with a promotion, perform actions to purchase goods and/or services from a retailer, etc.

Presentation module 345 may be a hardware processor that may receive information configured to be displayed on user interface 340 of client computing device 120. In embodiments, presentation module 345 may receive and present information associated with a user's profile, vehicle information, vehicle information, fuel prices of proximate retailers, and/or promotions. Presentation module 345 may also be configured to display the fuel prices of the lowest fuel prices of proximate retailers. Presentation module 345 may also be configured to continually connect client computing device 120 with a logic server or retailer computing device responsive to determining that the vehicle is low on fuel until completing a transaction associated with a promotion.

Presentation module 345 may also be configured to transmit information configured to be presented in a heat map on retailer computing devices. The heat map may be a colored representation of the density of vehicles over a geographic region that are low on fuel. Responsive to the density within the geographic region of vehicles low on fuel, retailers may be able to bid in real time to present promotions to the users of the vehicles that are low on fuel. A retailer's bid may include a discount price, a quantity of users able to redeem the promotion, a given time period, etc. For example, a first retailer's bid may be a promotion for twenty vehicles being given a ten cent per gallon discount and a second retailer's bid may be a promotion for ten vehicles being given fifteen cents per gallon discount. In embodiments, the retailer with the highest bid over a given time period will be awarded the opportunity to present the promotion to the vehicles being low on fuel within the geographic region. Utilizing the heat map, a retailer may be presented with how many vehicles have a low fuel metric over a geographic region. The low fuel metric may be any desired quantity of fuel or an estimate indicating when vehicles will have the low fuel metric based on the vehicle's current fuel level, vehicles driving patterns over a given time period, or the user's previous purchase behavior.

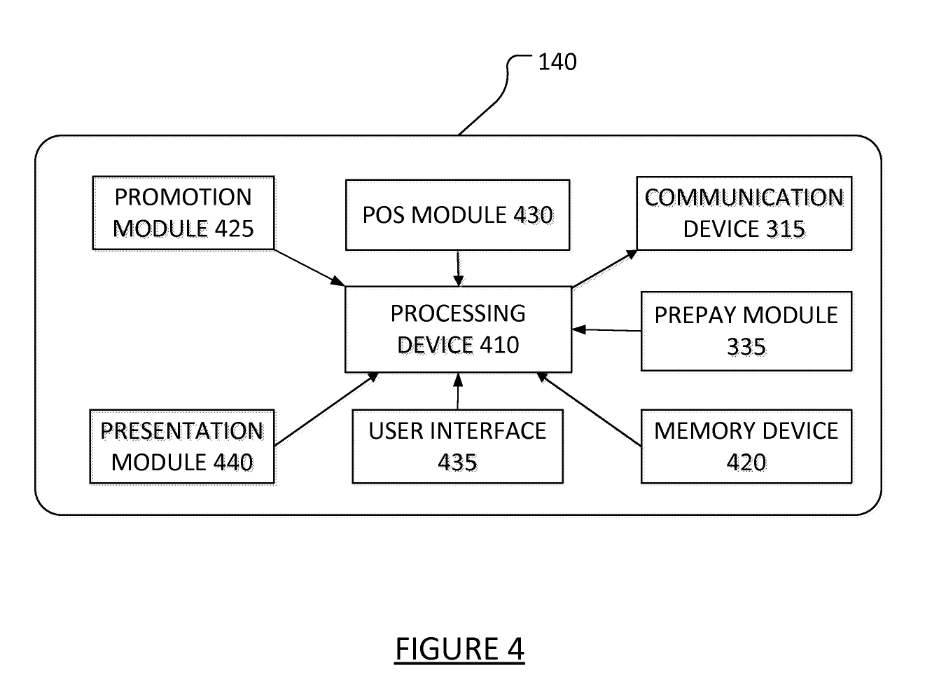

FIG. 4 depicts one embodiment of retailer computing device 140. Retailer computing device 140 may be configured to allow a retailer, an employee of a retailer or an administrator associated with a retailer to enter promotions for goods and/or services offered by the retailer. Utilizing retailer computing device 140 the entered promotions may by automatically pushed or transmitted to a set of client computing devices 120. The promotions may be transmitted to a vehicle responsive to receiving information identifying that the vehicle is low on fuel and in close proximity to the retailer.

Retailer computing device 140 may be a processor or any other type of computing device with a hardware processor that is configured to process instructions and connect to one or more portions of network 130. Retailer computing device 140 may include processing device 410, communication device 415, a memory device 420, a promotion module 425, a point of sale (POS) module 430, a user interface 435, and a presentation module 440.

Processing device 410 can include memory, e.g., read only memory (ROM) and random access memory (RAM), storing processor-executable instructions, and one or more processors that execute the processor-executable instructions. In embodiments where processing device 410 includes two or more processors, the processors may operate in a parallel or a distributed manner. Processing device 410 may execute an operating system of retailer computing device 140 or software associated with other elements of retailer computing device 140.

Communication device 415 may be a device that allows retailer computing device 140 to communicate with another device, e.g., a logic server or a client computing device over a network. Communication device 415 may include one or more wireless transceivers for performing wireless communication and/or one or more communication ports for performing wired communication.

Memory device 420 may be a device configured to store data generated or received by retailer computing device 140. Memory device 420 may include, but is not limited to a hard disc drive, an optical disc drive, and/or a flash memory drive. Memory device 420 may be configured to store data associated with promotions, a retailers location, a set of retailers locations associated with a chain or that are commonly owned, a retailers inventory, prices associated with fuel, etc.

Promotion module 425 may be a hardware processing device configured to receive business rules associated with a promotion for a retailer, and transmit the promotions over network 130. The business rules may be associated with determining a time when a promotion should be transmitted or what type of promotion for goods and/or services for the retailer should be transmitted to client computing devices associated with vehicles.

The business rules may be associated with a distance between the vehicle and the retailer, a time period, a received fuel metric associated with the vehicle or a vehicle's telematics information, and/or a number of vehicles within a given distance from the location of the retailer having a fuel metric being lower than a fuel threshold. The promotions may change over a time period, such that a greater discount may be provided during a heavy or light traffic time period.

In a first embodiment, a promotion may be a discount for an amount of fuel for a vehicle to be at maximum fuel capacity upon arriving at the retailer, without the amount of fuel exceeding the amount of fuel that may be required for the vehicle upon arriving at the retailer. In a second embodiment, the promotion may be associated with fuel, goods, and/or services offered by the retailer, such as snacks, drinks, car maintenance, etc., and may be presented in various forms such as cash, credit, rebate, reward points etc. In a third embodiment, the promotions may be an hourly sale to purchase fuel from the retailer, and if a sales quota is met then each user that used the promotion may receive a discount on the goods and/or service purchased upon the sales quota being met. In further embodiments, the amount of discount for a promotion may be proportional to the number of vehicles within the given distance from the retailer being below the fuel threshold. For example, the more vehicles below the fuel threshold within the given distance from the retailer, the greater the discount associated with the promotion. Thus, by utilizing different types of promotions at different time periods, a retailer may drive traffic to their location by selectively adjusting the promotions.

POS module 430 may be a hardware computing device including a processor to assist a user to complete a transaction. POS module 430 may include a credit card reader, a receipt printer, a NFC sensor, a cash drawer, a barcode scanner, and/or a personal identification number (PIN) pad with an integrated card swipe. POS module 430 may be configured to receive an amount of fuel required to fill up a vehicle to maximum capacity from a client computing device associated with the vehicle, determining a price for the amount of fuel required to fill up the vehicle, apply selected promotions to the price, and charge a payment method (e.g. a credit card, loyalty card, debit card, etc.) associated with the computing device. POS module 430 may be configured to automatically charge the user's payment method for the determined price for the amount of fuel required to fill up the vehicle. Thus, the user may not be required to directly perform actions on POS module 430 to purchase fuel, and only be required to perform actions on the client computing device to purchase fuel.

User interface 435 may be a device that allows an associated of a retail store to interact with retailer computing device 140, logic server, or a client computing device over a network. While one user interface is shown, the term “user interface” may include, but is not limited to being, a touch screen, a physical keyboard, a mouse, a camera, a video camera, a microphone, and/or a speaker. Utilizing user interface 435, an associate of the retailer may enter promotions for the retailer.

Presentation module 440 may be a hardware processor to receive information configured to be displayed on user interface 435 of retailer computing device 140. In embodiments, presentation module 440 may receive and present information associated with a user's profile, vehicle information, vehicle information, payment methods, promotions, etc.

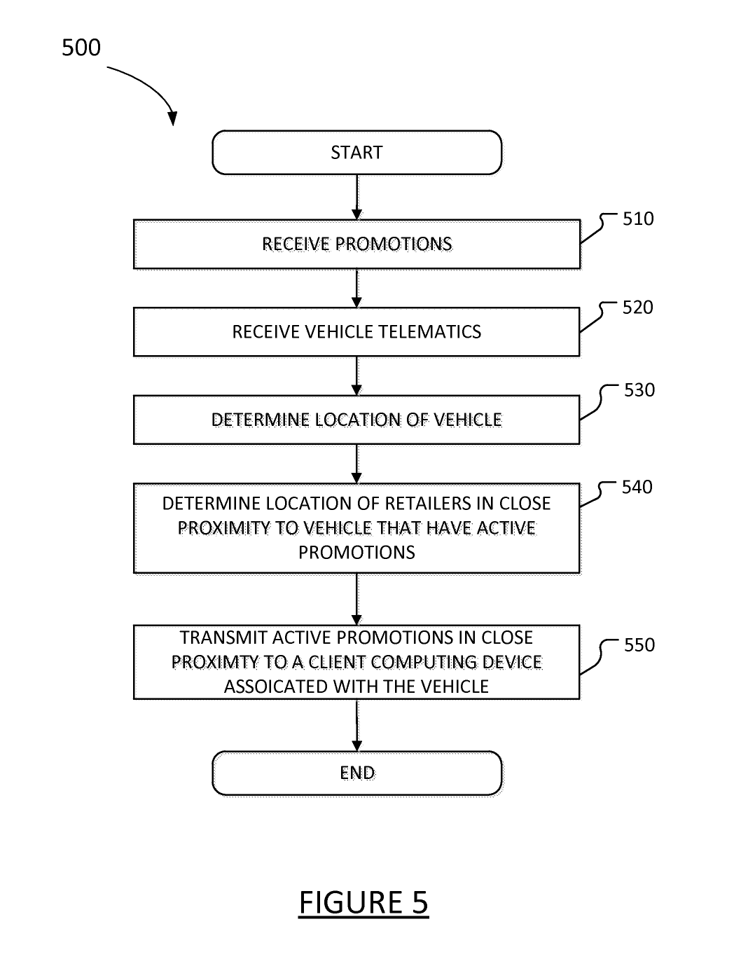

FIG. 5 illustrates a method 500 for transmitting promotions responsive to a level of fuel in a vehicle being lower than a fuel threshold. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 510, promotions associated with goods and/or services from a retailer may be received. The received promotions may be a price discount off an amount of fuel from at least one retailer. Operation 510 may be performed by a retailer module that is the same as or similar to retailer module 230, in accordance with one or more implementations.

At operation 520, vehicle telematics associated with a vehicle may be received. The vehicle telematics may be associated with an amount of fuel within the vehicle, and may be transmitted responsive to the amount of fuel within the vehicle being below a fuel threshold. In embodiments, the amount of fuel within the vehicle may be determined by at least one sensor embedded within or communicatively coupled to a fuel tank of the vehicle. Operation 520 may be performed by a vehicle metric module that is the same as or similar to vehicle metric module 225, in accordance with one or more implementations.

At operation 530, a location of the vehicle may be determined. The location of the vehicle may be determined responsive to determining that the amount of fuel within the vehicle is below the fuel threshold or the amount of fuel within the vehicle triggering a sensor within the vehicle (e.g. the low fuel light within the vehicle). Operation 530 may be performed by a location module that is the same as or similar to location module 220, in accordance with one or more implementations.

At operation 540, retailers having active promotions for fuel within a given distance from the vehicle may be determined. The given distance may be any desired distance from the given vehicle at a current location of the vehicle or at the vehicle's location when it is determined that the amount of fuel within the vehicle is below the fuel threshold. The retailers having active promotions for fuel within the given distance may be determined by time periods associated with the active promotions, the locations of the retailers associated with the active promotions, and the location of the vehicle. Operation 540 may be performed by a distance module that is the same as or similar to distance module 235, in accordance with one or more implementations.

At operation 550, the active promotions for retailers within the given distance may be transmitted. In embodiments, the promotions may include a discount on fuel, a map, locations of the corresponding retailer, and directions from the vehicle to a retailer associated with a selected promotion. Operation 550 may be performed by a presentation module 250 that is the same as or similar to presentation module 250, in accordance with one or more implementations.

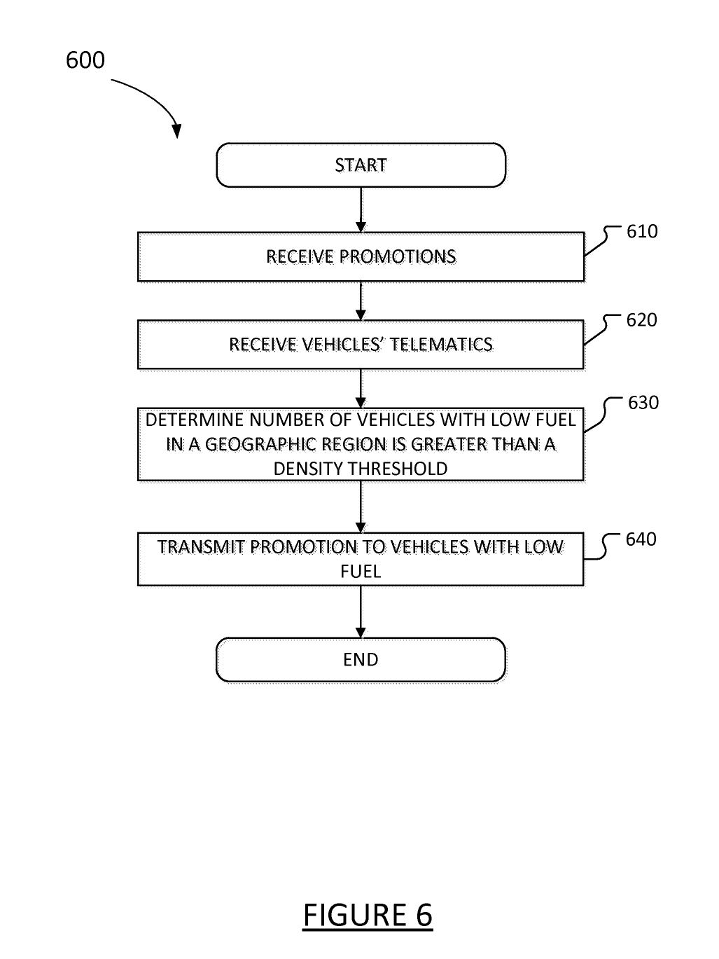

FIG. 6 illustrates a method 600 for transmitting a promotion to a plurality of client computing devices associated with different vehicles responsive to determining a level of fuel in the vehicles being lower than a fuel threshold. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At operation 610, promotions associated with goods and/or services from a retailer may be received. The received promotions may be a price discount off an amount of fuel from at least one promotion, which may be valid if a number of vehicles within a geographic region have transmitting information indicating that the vehicle is low on fuel over a period a time. Operation 610 may be performed by a retailer module that is the same as or similar to retailer module 230, in accordance with one or more implementations.

At operation 620, vehicle telematics associated with a plurality of vehicles may be received. The vehicle telematics may be associated with an amount of fuel within the vehicles, and may be transmitted responsive to the amount of fuel within the vehicles being below a fuel threshold. Operation 620 may be performed by a vehicle metric module that is the same as or similar to vehicle metric module 225, in accordance with one or more implementations.

At operation 630, a number of vehicles transmitting telematics having an amount of fuel that is lower than a fuel threshold may be determined, and the determined number may be greater than a density threshold over a period of time for a geographic region. In embodiments, the period of time may be any desired period of time and the geographic region may be any desired distance from a retailer associated with a promotion. Operation 630 may be performed by a density module that is the same as or similar to density module 235, in accordance with one or more implementations.

At operation 640, the promotion for the retailer may be transmitted to the client computing devices associated with the vehicles with a low level of fuel within the geographic area. In embodiments, the promotions may include a discount on fuel, a map, locations of the corresponding retailer, and directions from the vehicle to a retailer associated with a selected promotion. Operation 640 may be performed by a presentation module 250 that is the same as or similar to presentation module 250, in accordance with one or more implementations.

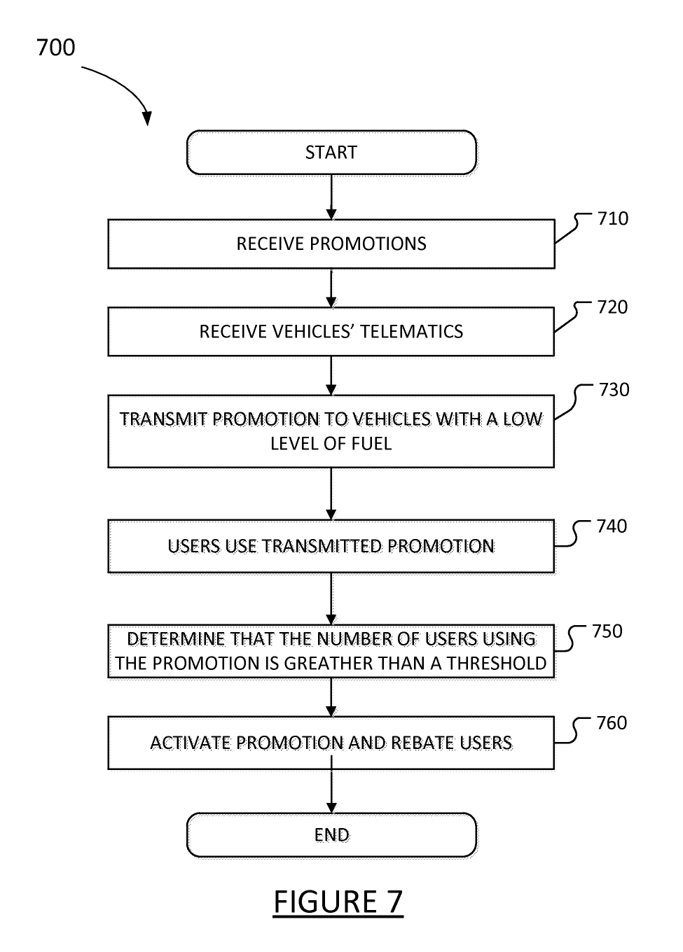

FIG. 7 illustrates a method 700 for activating a promotion if enough users purchase goods and/or services associated with the promotion over a given time period. The operations of method 700 presented below are intended to be illustrative. In some embodiments, method 700 may be accomplished with one or more additional operations not described, and/or without one or more of the operations discussed. Additionally, the order in which the operations of method 700 are illustrated in FIG. 7 and described below is not intended to be limiting.

In some embodiments, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

At operation 710, promotions associated with goods and/or services from a retailer may be received. The received promotions may be a price discount off an amount of fuel from at least one promotion. In embodiments, the promotion may be activated responsive to a number of users using the promotion to purchase goods and/or services associated with the promotion over a time period or a quantity of goods and/or services associated with the promotion being purchased over the time period. Operation 710 may be performed by a retailer module that is the same as or similar to retailer module 230, in accordance with one or more implementations.

At operation 720, vehicle telematics associated with a vehicle may be received. The vehicle telematics may be associated with an amount of fuel within the vehicle, and may be transmitted responsive to the amount of fuel within the vehicle being below a fuel threshold. In embodiments, the amount of fuel within the vehicle may be determined by at least one sensor embedded with or communicatively coupled to a fuel tank of the vehicle. Operation 720 may be performed by a vehicle metric module that is the same as or similar to vehicle metric module 225, in accordance with one or more implementations.

At operation 730, the promotions for the retailer may be transmitted to client computing devices associated with vehicles having the amount of fuel within the vehicle being below the fuel threshold. In embodiments, the promotions may include a discount on fuel, a map, locations of the corresponding retailer, and directions from the vehicle to a retailer associated with a selected promotion. Operation 730 may be performed by a presentation module that is the same as or similar to presentation module 250, in accordance with one or more implementations.

At operation 740, a number of users receiving the promotion may visit the retailer, select the promotion, and purchase goods and/or services associated with the promotion. Operation 740 may be performed by a retailer module that is the same as or similar to retailer module 230, in accordance with one or more implementations.

At operation 750, it may be determined that the number of users using the promotion to purchase goods and/or services is greater than a number threshold and/or that the sales associated with the promotion is greater than a quantity threshold. Operation 750 may be performed by a retailer module that is the same as or similar to retailer module 230, in accordance with one or more implementations.

At operation 760, responsive to the number threshold or the sales threshold being met, the promotions may be activated. In embodiments, an activated promotion may transmit a rebate to a credit, debit, or other card that the user used to complete a transaction to purchase the goods and/or services associated with the promotion. In other embodiments, responsive to a promotion being activate loyalty points or rewards may be transmitted to client computing devices associated with users that utilized the promotion to purchase goods and/or services. Operation 760 may be performed by a retailer module that is the same as or similar to retailer module 230, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system to communicate promotions, the system comprising:
a vehicle metric module configured to receive vehicle information associated with the vehicle, the vehicle information including a vehicle location identifying a location of the vehicle and an amount of fuel within the vehicle;
a retailer module configured to receive a promotion associated with a retailer, the promotion including a discount for a good or service carried by the retailer and a retailer location identifying a location of the retailer;
a distance module configured to determine a distance between the retailer and the vehicle based on the vehicle location and the retailer location responsive to the amount of fuel within the vehicle being below a fuel threshold; and
a presentation module configured to transmit the promotion to the vehicle responsive to determining that the amount of fuel within the vehicle is below the fuel threshold and the distance between the retailer and the vehicle is less than a distance threshold.

2. The system of claim 1, wherein the promotion includes a discount of a price of fuel.

3. The system of claim 1, wherein the system further comprises:
a density module, the density module being configured to determine a number of vehicles within a given geographic region having an amount of fuel within a corresponding vehicle being below the fuel threshold.

4. The system of claim 3, wherein the presentation module is configured to:
transmit the promotions to the vehicles within the given geographic region having the amount of fuel within the vehicle being below the fuel threshold responsive to a number of the vehicles within the geographic region having the amount of fuel being below the fuel threshold is greater than a quantity threshold.

5. The system of claim 1, wherein the retailer module is configured to:
receive a first promotion associated with a first retailer and a second promotion associated with a second retailer; and
the presentation module is configured to transmit the first promotion or the second promotion to the vehicle based on a price discount associated with the first promotion and the second promotion.

6. The system of claim 1, wherein the distance module is configured to:
determine an amount of fuel required for the vehicle to travel from the vehicle location to the retailer location, the received vehicle information further including a maximum amount of fuel capable of being held by the vehicle, and the promotion being associated with the amount of fuel required for the vehicle to travel from the vehicle location to the retailer location, the amount of fuel within the vehicle, and the maximum amount of fuel capable of being held by the vehicle.

7. The system of claim 6, further comprising:
a prepay module configured to determine a price for a top off amount of fuel for the vehicle responsive to receiving a selection of the promotion, the top off amount of fuel being based on the amount of fuel required for the vehicle to travel from the vehicle location to the retailer location, the amount of fuel within the vehicle, and the maximum amount of fuel capable of being held by the vehicle.

8. The system of claim 7, wherein the prepay module is configured to:
automatically charge a method of payment for the price for the top off amount of fuel responsive to receiving the selection of the promotion.

9. The system of claim 1, wherein the promotion includes a sales quota, responsive to the sales quota being met users using the promotion receive a rebate.

10. The system of claim 1, wherein the promotion includes a period of time and a number of users able to redeem the promotion, wherein the promotion is transmitted to more vehicles than the number of users able to redeem the promotion.

11. A method comprising:
receiving vehicle information associated with the vehicle, the vehicle information including a vehicle location identifying a location of the vehicle and an amount of fuel within the vehicle;
receiving a promotion associated with a retailer, the promotion including a discount for a good or service carried by the retailer and a retailer location identifying a location of the retailer;
determining a distance between the retailer and the vehicle based on the vehicle location and the retailer location responsive to the amount of fuel within the vehicle being below a fuel threshold; and
transmitting the promotion to the vehicle responsive to determining that the amount of fuel within the vehicle is below the fuel threshold and the distance between the retailer and the vehicle is less than a distance threshold.

12. The method of claim 11, wherein the promotion includes a discount of a price of fuel.

13. The method of claim 11, further comprising:
determining a number of vehicles within a given geographic region having an amount of fuel within a corresponding vehicle being below the fuel threshold.

14. The method of claim 13, further comprising:
transmitting the promotions to the vehicles within the given geographic region having the amount of fuel within the vehicle being below the fuel threshold responsive to a number of the vehicles within the geographic region having the amount of fuel being below the fuel threshold is greater than a quantity threshold.

15. The method of claim 11, further comprising:
receiving a first promotion associated with a first retailer and a second promotion associated with a second retailer; and
transmitting the first promotion or the second promotion to the vehicle based on a price discount associated with the first promotion and the second promotion.

16. The method of claim 11, further comprising:
determining an amount of fuel required for the vehicle to travel from the vehicle location to the retailer location, wherein the received vehicle information further includes a maximum amount of fuel capable of being held by the vehicle, and the promotion being associated with the amount of fuel required for the vehicle to travel from the vehicle location to the retailer location, the amount of fuel within the vehicle, and the maximum amount of fuel capable of being held by the vehicle.

17. The method of claim 16, further comprising:
determining a price for a top off amount of fuel for the vehicle responsive to receiving a selection of the promotion, the top off amount of fuel being based on the amount of fuel required for the vehicle to travel from the vehicle location to the retailer location, the amount of fuel within the vehicle, and the maximum amount of fuel capable of being held by the vehicle.

18. The method of claim 17, further comprising:
automatically charging a method of payment for the price for the top off amount of fuel responsive to receiving the selection of the promotion.

19. The method of claim 11, wherein the promotion includes a sales quota, responsive to the sales quota being met users using the promotion receive a rebate.

20. The method of claim 11, wherein the promotion includes a period of time and a number of users able to redeem the promotion, wherein the promotion is transmitted to more vehicles than the number of users able to redeem the promotion.
